(19) United States
(12) Patent Application Publication
(10) Pub. No.: US 2021/0247648 A1
(43) Pub. Date: Aug. 12, 2021

(54) PIXEL STRUCTURE AND DISPLAY PANEL

(71) Applicant: Shenzhen China Star Optoelectronics Semiconductor Display Technology Co., Ltd., Shenzhen, Guangdong (CN)

(72) Inventor: Yinfeng ZHANG, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/981,714

(22) PCT Filed: Jan. 21, 2020
(86) PCT No.: PCT/CN2020/073440

§ 371 Date: Sep. 17, 2020

(30) Foreign Application Priority Data
Jan. 8, 2020 (CN) 202010018201.X

(51) Int. Cl. G02F 1/1343

(52) U.S. Cl. CPC G02F 1/134336; G02F 1/134345

(57) ABSTRACT

The disclosure provides a pixel structure, including a plurality of first pixels and a plurality of second pixels arranged in an array manner. The pixel structure includes a first direction and a second direction. The first pixels and the second pixels are alternately disposed along the first direction. An even number of the first pixels are arranged in a side-by-side manner along the second direction to form a first unit, an even number of the second pixels are arranged in a side-by-side manner along the second direction to form a second unit, and the first unit and the second unit are alternately disposed.

### FIELD

The present disclosure relates to the field of display technologies, and more particularly, relates to a pixel structure and a display panel. BACKGROUND

With development of display technologies, high vertical alignment (HVA) mode liquid crystal display (LCD) devices are widely utilized due to advantages such as high contrast and fast response times.

To obtain HVA mode LCD devices with wider viewing angles, a multi-domain pixel design is commonly used. Specifically, a single sub-pixel is divided into several regions to improve viewing angle performance.

However, a conventional arrangement of pixels can only fix a color shifting problem at large viewing angles when an entire panel emits light. The color shifting problem still happens when high-end devices display special images. Therefore, how to fix the color shifting problem of special images is a technical problem that needs to be solved.

### SUMMARY

The present disclosure provides a pixel structure and a display panel to fix a color shifting problem of special images.

The present disclosure provides a pixel structure, including a plurality of first pixels and a plurality of second pixel arranged in an array manner, wherein the pixel structure includes a first direction and a second direction.

The first pixels include a plurality of first pixel electrodes, the second pixels include a plurality of second pixel electrodes, a plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes.

The first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed.

The first unit includes two of the first pixels, the second unit includes two of the second pixels, and the first direction is perpendicular to the second direction.

In the pixel structure of the present disclosure, the first direction is a row direction or a column direction, and the second direction is the row direction or the column direction.

In the pixel structure of the present disclosure, each of the first pixels includes a first partition and a second partition, and each of the first pixel electrodes includes a first sub-pixel electrode and a second sub-pixel electrode. The first sub-pixel electrode is disposed in the first partition, the second sub-pixel electrode is disposed in the second partition, and a pattern of the first sub-pixel electrode and a pattern of the second sub-pixel electrode are different.

The second pixels include a third partition and a fourth partition, and each of the second pixel electrodes includes a third sub-pixel electrode and a fourth sub-pixel electrode. The third sub-pixel electrode is disposed in the third partition, the fourth sub-pixel electrode is disposed in the fourth partition, and a pattern of the third sub-pixel electrode and a pattern of the fourth sub-pixel electrode are different.

In the pixel structure of the present disclosure, each of the first pixel electrodes further includes a first trunk electrode line disposed between the first sub-pixel electrode and the second sub-pixel electrode, and the pattern of the first sub-pixel electrode and the pattern of the second sub-pixel electrode are symmetrically disposed with respect to the first trunk electrode line.

Each of the second pixel electrodes further includes a second trunk electrode line disposed between the third sub-pixel electrode and the fourth sub-pixel electrode, and the pattern of the third sub-pixel electrode and the pattern of the fourth sub-pixel electrode are symmetrically disposed with respect to the second trunk electrode line.

In the pixel structure of the present disclosure, the first sub-pixel electrode includes a plurality of first branch electrodes parallelly arranged, and an extending direction of the first branch electrodes intersects an extending direction of the first trunk electrode line. The second sub-pixel electrode includes a plurality of second branch electrodes parallelly arranged, and an extending direction of the second branch electrodes intersects the extending direction of the first trunk electrode line. The first branch electrodes and the second branch electrodes are symmetrically disposed with respect to the first trunk electrode line.

The third sub-pixel electrode includes a plurality of third branch electrodes parallelly arranged, and an extending direction of the third branch electrodes intersects an extending direction of the second trunk electrode line. The fourth sub-pixel electrode includes a plurality of fourth branch electrodes parallelly arranged, and an extending direction of the fourth branch electrodes intersects the extending direction of the second trunk electrode line. The third branch electrodes and the fourth branch electrodes are symmetrically disposed with respect to the second trunk electrode line.

In the pixel structure of the present disclosure, the first branch electrodes, the second branch electrodes, the third branch electrodes, and the fourth branch electrodes are strip-shaped electrodes.

In the pixel structure of the present disclosure, an included angle between the extending direction of the first branch electrodes and the extending direction of the first trunk electrode line and an included angle between the extending direction of the second branch electrodes and the extending direction of the first trunk electrode line are 45°.

In the pixel structure of the present disclosure, an included angle between the extending direction of the third branch electrodes and the extending direction of the second trunk electrode line and an included angle between the extending direction of the fourth branch electrodes and the extending direction of the second trunk electrode line are 45°.

The present disclosure further provides a pixel structure, including a plurality of first pixels and a plurality of second pixels arranged in an array manner. The pixel structure includes a first direction and a second direction. The first pixels include a plurality of first pixel electrodes, and the second pixels include a plurality of second pixel electrodes. A plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes.

The first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed.

In the pixel structure of the present disclosure, the first unit includes two of the first pixels, and the second unit includes two of the second pixels.

In the pixel structure of the present disclosure, the first direction is perpendicular to the second direction.

In the pixel structure of the present disclosure, the first direction is a row direction or a column direction, and the second direction is the row direction or the column direction.

In the pixel structure of the present disclosure, each of the first pixels includes a first partition and a second partition, and each of the first pixel electrodes includes a first sub-pixel electrode and a second sub-pixel electrode. The first sub-pixel electrode is disposed in the first partition, the second sub-pixel electrode is disposed in the second partition, and a pattern of the first sub-pixel electrode and a pattern of the second sub-pixel electrode are different.

Each of the second pixels includes a third partition and a fourth partition, and each of the second pixel electrodes includes a third sub-pixel electrode and a fourth sub-pixel electrode. The third sub-pixel electrode is disposed in the third partition, the fourth sub-pixel electrode is disposed in the fourth partition, and a pattern of the third sub-pixel electrode and a pattern of the fourth sub-pixel electrode are different.

In the pixel structure of the present disclosure, each of the first pixel electrodes further includes a first trunk electrode line disposed between the first sub-pixel electrode and the second sub-pixel electrode, and the pattern of the first sub-pixel electrode and the pattern of the second sub-pixel electrode are symmetrically disposed with respect to the first trunk electrode line.

Each of the second pixel electrodes further includes a second trunk electrode line disposed between the third sub-pixel electrode and the fourth sub-pixel electrode, and the pattern of the third sub-pixel electrode and the pattern of the fourth sub-pixel electrode are symmetrically disposed with respect to the second trunk electrode line.

In the pixel structure of the present disclosure, the first sub-pixel electrode includes a plurality of first branch electrodes parallelly arranged, and an extending direction of the first branch electrodes intersects an extending direction of the first trunk electrode line. The second sub-pixel electrode includes a plurality of second branch electrodes parallelly arranged, and an extending direction of the second branch electrodes intersects the extending direction of the first trunk electrode line. The first branch electrodes and the second branch electrodes are symmetrically disposed with respect to the first trunk electrode line.

The third sub-pixel electrode includes a plurality of third branch electrodes parallelly arranged, and an extending direction of the third branch electrodes intersects an extending direction of the second trunk electrode line. The fourth sub-pixel electrode includes a plurality of fourth branch electrodes parallelly arranged, and an extending direction of the fourth branch electrodes intersects the extending direction of the second trunk electrode line. The third branch electrodes and the fourth branch electrodes are symmetrically disposed with respect to the second trunk electrode line.

In the pixel structure of the present disclosure, the first branch electrodes, the second branch electrodes, the third branch electrodes, and the fourth branch electrodes are strip-shaped electrodes.

In the pixel structure of the present disclosure, an included angle between the extending direction of the first branch electrodes and the extending direction of the first trunk electrode line and an included angle between the extending direction of the second branch electrodes and the extending direction of the first trunk electrode line are 45°.

In the pixel structure of the present disclosure, an included angle between the extending direction of the third branch electrodes and the extending direction of the second trunk electrode line and an included angle between the extending direction of the fourth branch electrodes and the extending direction of the second trunk electrode line are 45°.

The present disclosure further provides a display panel, including a pixel electrode, wherein the pixel structure includes a plurality of first pixels and a plurality of second pixels arranged in an array manner, and the pixel structure includes a first direction and a second direction.

The first pixels include a plurality of first pixel electrodes, the second pixels include a plurality of second pixel electrodes, a plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes.

The first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed.

In the display panel of the present disclosure, the first unit includes two of the first pixels, and the second unit includes two of the second pixels.

In the display panel of the present disclosure, the first direction is perpendicular to the second direction.

In the display panel of the present disclosure, the first direction is a row direction or a column direction, and the second direction is the row direction or the column direction.

Regarding the beneficial effects: compared with conventional pixel structures, in a pixel structure provided by the present disclosure, a plurality of first pixels and a plurality of second pixels are alternately disposed along a first direction, an even number of the first pixels are disposed in a side-by-side manner along the second direction to form a first unit, an even number of the second pixels are disposed in a side-by-side manner along the second direction to form a second unit, and the first unit and the second unit are alternately disposed along the second direction. Therefore, a color shifting problem of special images displayed by high-end devices is fixed.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic structural view showing a first pixel A of the pixel structure provided by an embodiment of the present disclosure.

FIG. 2 is a schematic structural view showing a second pixel B of the pixel structure provided by an embodiment of the present disclosure.

FIG. 3 is a first schematic structural view showing a pixel structure provided by an embodiment of the present disclosure.

FIG. 4 is a schematic structural view showing the pixel structure arranged along a first direction X in FIG. 3.

FIG. 5 is a schematic structural view showing the pixel structure arranged along a second direction Y in FIG. 3.

FIG. 6 is a second schematic structural view showing a pixel structure provided by an embodiment of the present disclosure.

FIG. 7 is a schematic structural view showing the pixel structure arranged along the first direction X in FIG. 6.

FIG. 8 is a schematic structural view showing the pixel structure arranged along the second direction Y in FIG. 6.

FIG. 9 is a schematic structural view showing the pixel structure in FIG. 3 when a first special image is displayed.

FIG. 10 is a schematic structural view showing the pixel structure in FIG. 3 when a second special image is displayed.

### DETAILED DESCRIPTION

Hereinafter a preferred embodiment of the present disclosure will be described with reference to the accompanying drawings to exemplify the embodiments of the present disclosure can be implemented, which can fully describe the technical contents of the present disclosure to make the technical content of the present disclosure clearer and easy to understand. However, the described embodiments are only some of the embodiments of the present disclosure, but not all of the embodiments. All other embodiments obtained by those skilled in the art based on the embodiments of the present disclosure without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counter-clockwise”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrate connection; it can mean a mechanical connection, an electrical connection, or can communicate with each other; it can mean a direct connection, an indirect connection by an intermediate, or an inner communication or an interreaction between two elements. A person skilled in the art should understand the specific meanings in the present disclosure according to specific situations.

In the description of the present disclosure, unless specified or limited otherwise, it should be noted that a structure in which a first feature is “on” or “beneath” a second feature may include an embodiment in which the first feature directly contacts the second feature and may also include an embodiment in which an additional feature is formed between the first feature and the second feature so that the first feature does not directly contact the second feature. Furthermore, a first feature “on,” “above,” or “on top of” a second feature may include an embodiment in which the first feature is right “on,” “above,” or “on top of” the second feature and may also include an embodiment in which the first feature is not right “on,” “above,” or “on top of” the second feature, or just means that the first feature has a sea level elevation greater than the sea level elevation of the second feature. While first feature “beneath,” “below,” or “on bottom of” a second feature may include an embodiment in which the first feature is right “beneath,” “below,” or “on bottom of” the second feature and may also include an embodiment in which the first feature is not right “beneath,” “below,” or “on bottom of” the second feature, or just means that the first feature has a sea level elevation less than the sea level elevation of the second feature.

The disclosure below provides many different embodiments or examples for realizing different structures of the present disclosure. In order to simplify the disclosure of the present disclosure, components and settings of specific examples are described below. Of course, they are only examples and are not intended to limit the present disclosure. Furthermore, reference numbers and/or letters may be repeated in different examples of the present disclosure. Such repetitions are for simplification and clearness, which per se do not indicate the relations of the discussed embodiments and/or settings. Moreover, the present disclosure provides examples of various specific processes and materials, but the applicability of other processes and/or application of other materials may be appreciated by a person skilled in the art.

It should be noted that first pixels and second pixels of the present disclosure may be two-domain pixels or multi-domain pixels. In embodiments of the present disclosure, the first pixels and the second pixels are two-domain pixels, but are not limited thereto.

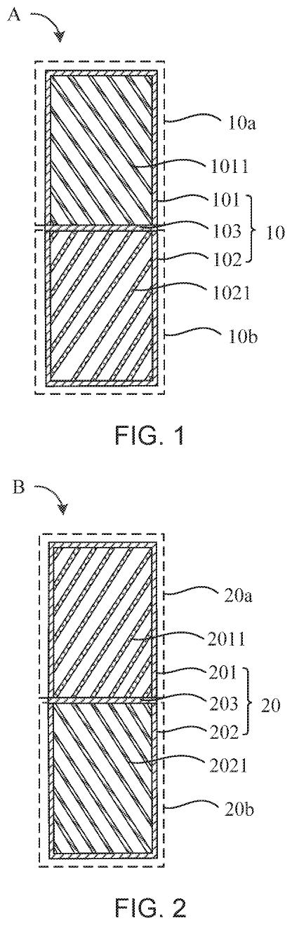

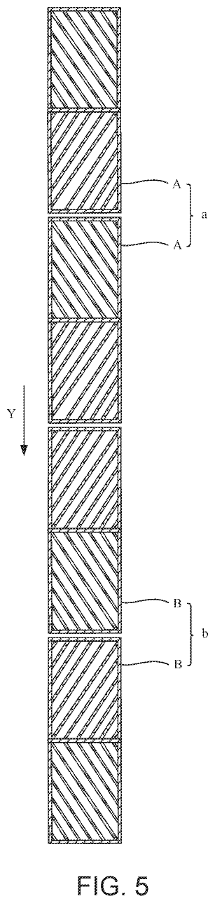

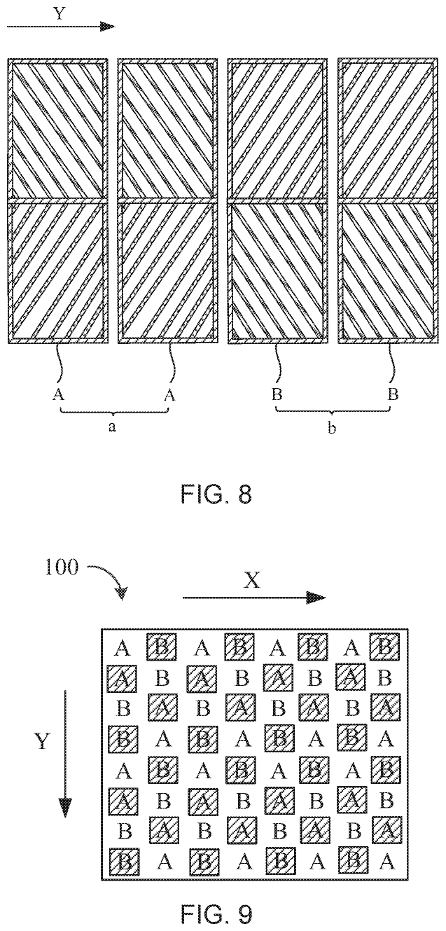

Please refer to FIG. 1 to FIG. 8. A pixel structure 100 provided by the present disclosure includes a plurality of first pixels A and a plurality of second pixels B arranged in an array manner. The pixel structure 100 includes a first direction X and a second direction Y. The first pixels A include a plurality of first pixel electrodes 10, and the second pixels B include a plurality of second pixel electrodes 20. A plurality of patterns of the first pixel electrodes 10 are symmetrically disposed with respect to a plurality of patterns of the second pixel electrodes 20, and the plurality of patterns of the second pixel electrodes 20 are symmetrically disposed with respect to the plurality of patterns of the first pixel electrodes 10. The first pixels A and the second pixels B are alternately disposed along the first direction X. An even number of the first pixels A are arranged in a side-by-side manner along the second direction Y to form a first unit a, and an even number of the second pixels B are arranged in a side-by-side manner along the second direction Y to form a second unit b. The first unit a and the second unit b are alternately disposed.

As a result, in the pixel structure 100 provided by the present embodiment, the first pixels A and the second pixels B are alternately disposed along a first direction X, an even number of the first pixels A are disposed in a side-by-side manner along the second direction Y to form the first unit a, an even number of the second pixels B are disposed in a side-by-side manner along the second direction Y to form a second unit b, and the first unit a and the second unit b are alternately disposed along the second direction Y. Therefore, a color shifting problem of special images displayed by high-end devices is fixed.

Specifically, in the present embodiment, the first direction X is perpendicular to the second direction Y.

In some embodiments, an acute included angle or an obtuse included angle may be formed between the first direction X and the second direction Y. Specific positions of the first direction X and the second direction Y may be decided according to a practical situation, and are not limited here.

In the present embodiment, the first unit a includes two first pixels A, and the second pixel b includes two second pixels B.

In some embodiments, the first unit a includes four first pixels A, and the second unit b includes four second pixels B. However, a number of the first pixels A in the first unit a and a number of the second pixels B in the second unit b may be decided according to a practical requirement, and are not limited here.

Selectively, the first direction X is a row direction or a column direction, and the second direction Y is the row direction or the column direction.

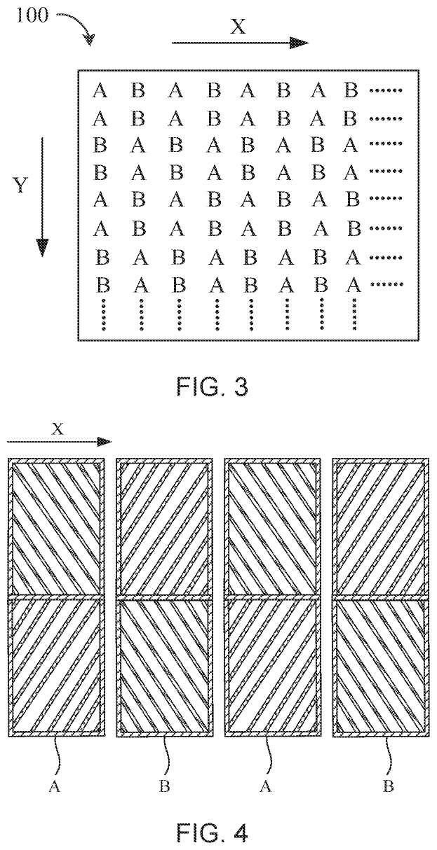

Furthermore, please keep referring to FIG. 3 to FIG. 5. In the present embodiment, when the first direction X is the row direction and the second direction Y is the column direction, the first pixels A and the second pixels B are alternately arranged along the row direction, and two first pixels A and two second pixels B are alternately arranged along the column direction.

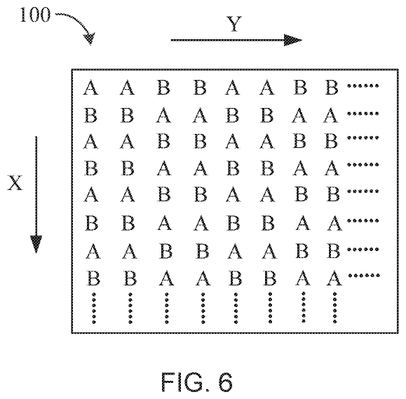

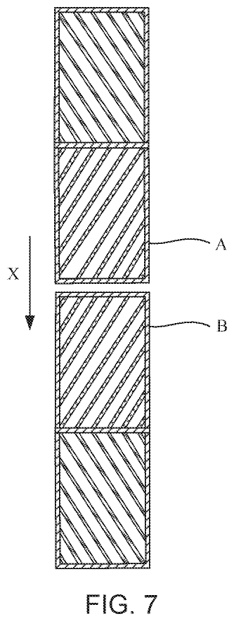

In addition, in the present embodiment, as shown in FIG. 6 to FIG. 8, when the first direction X is the column direction and the second direction Y is the row direction, the first pixels A and the second pixels B are alternately arranged along the column direction, and two first pixels A and two second pixels B are alternately arranged along the row direction.

The first pixels A and the second pixels B are alternately arranged along the row direction, and two first pixels A and two second pixels B are alternately arranged along the column direction. Alternatively, the first pixels A and the second pixels B are alternately arranged along the column direction, and two first pixels A and two second pixels B are alternately arranged along the row direction. Therefore, the first pixels A and the second pixels B in the pixel structure 100 are orderly arranged in any diagonal direction. As a result, a color shifting problem of special images is fixed, and a viewing angle is effectively compensated.

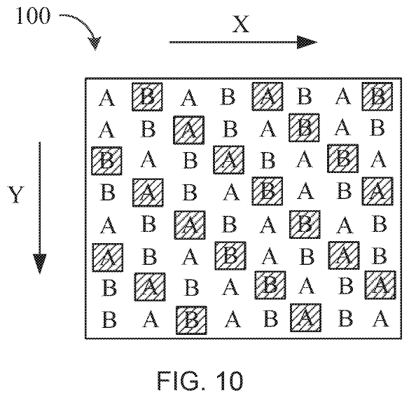

Specifically, please refer to FIG. 9 and FIG. 10. FIG. 9 is a schematic structural view showing the pixel structure in FIG. 3 when a first special image is displayed, and FIG. 10 is a schematic structural view showing the pixel structure in FIG. 3 when a second special image is displayed. When the first special image and the second special image are displayed for a testing purpose, the first pixels A and the second pixels are orderly arranged in a BAAB arrangement in any diagonal direction. Therefore, a color shifting problem of every single pixel in a diagonal direction can be eliminated.

Please keep referring to FIG. 1 and FIG. 2. Specifically, each of the first pixels A includes a first partition 10a and a second partition 10b, and each of the first pixel electrodes 10 includes a first sub-pixel electrode 101 and a second sub-pixel electrode 102. The first sub-pixel electrode 101 is disposed in the first partition 10a, the second sub-pixel electrode 102 is disposed in the second partition 10b, and a pattern of the first sub-pixel electrode 101 and a pattern of the second sub-pixel electrode 102 are different.

Each of the second pixels B includes a third partition 20a and a fourth partition 20b, and each of the second pixel electrodes 20 includes a third sub-pixel electrode 201 and a fourth sub-pixel electrode 202. The third sub-pixel electrode 201 is disposed in the third partition 20a, the fourth sub-pixel electrode 202 is disposed in the fourth partition 20b, and a pattern of the third sub-pixel electrode 201 and a pattern of the fourth sub-pixel electrode 202 are different.

In conventional four-domain high vertical alignment (HVA) mode liquid crystal display (LCD) devices, black stripes will appear on a middle portion of a screen, which reduces light transmittance of a display panel. In the present embodiment, each of the first pixels A is divided into the first partition 10a and the second partition 10b, and each of the second pixels B is divided into the third partition 20a and the fourth partition 20b. By the above two-domain pixel design, not only can a color shifting problem be fixed, but a possibility of black stripes appearing on a middle portion of a screen can be reduced as well. As a result, a light transmittance of a display panel increases.

It should be noted that the pixel structure of the present disclosure further includes a thin film transistor (TFT). The first pixels A and the second pixels B can be driven by only one TFT or may be driven by multiple TFTs. Driving methods of the first pixels A and the second pixels B may be obtained according to conventional technologies, and are not described here.

In the present embodiment, the first pixel electrode 10 further includes a first trunk electrode line 103 as shown in FIG. 1. The first trunk electrode line 103 is disposed between the first sub-pixel electrode 101 and the second sub-pixel electrode 102, and a pattern of the first sub-pixel electrode 101 and a pattern of the second sub-pixel electrode 102 are symmetrically disposed with respect to the first trunk electrode line 103.

Furthermore, the first sub-pixel electrode 101 includes a plurality of first branch electrodes 1011 parallelly arranged, and an extending direction of the first branch electrodes 1011 intersects an extending direction of the first trunk electrode line 103. The second sub-pixel electrode 102 includes a plurality of second branch electrodes 1021 parallelly arranged, and an extending direction of the second branch electrodes 1021 intersects the extending direction of the first trunk electrode line 103. The first branch electrodes 1011 and the second branch electrodes 1021 are symmetrically disposed with respect to the first trunk electrode line 103.

As shown in FIG. 2, the second pixel electrode 20 further includes a second trunk electrode line 203. The second trunk electrode line 203 is disposed between the third sub-pixel electrode 201 and the fourth sub-pixel electrode 202, and a pattern of the third sub-pixel electrode 201 and a pattern of the fourth sub-pixel electrode 202 are symmetrically disposed with respect to the second trunk electrode line 203.

Furthermore, the third sub-pixel electrode 201 includes a plurality of third branch electrodes 2011 parallelly arranged, and an extending direction of the third branch electrodes 2011 intersects an extending direction of the second trunk electrode line 203. The fourth sub-pixel electrode 202 includes a plurality of fourth branch electrodes 2021 parallelly arranged, and an extending direction of the fourth branch electrodes 2021 intersects an extending direction of the second trunk electrode line 203. The third branch electrodes 2011 and the fourth branch electrodes 2021 are symmetrically disposed with respect to the second trunk electrode line 203.

In the present embodiment, the first branch electrodes 1011, the second branch electrodes 1021, the third branch electrodes 2011, and the fourth branch electrodes 2021 are strip-shaped electrodes. In addition, specific shapes of the first branch electrodes 1011, the second branch electrodes 1021, the third branch electrodes 2011, and the fourth branch electrodes 2021 can be decided according to a practical requirement, and are not limited here.

Furthermore, an included angle between the extending direction of the first branch electrodes 1011 and the extending direction of the first trunk electrode line 103 and an included angle between the extending direction of the second branch electrodes 1021 and the extending direction of the first trunk electrode line 103 are 45°. Furthermore, an included angle between the extending direction of the third branch electrodes 2011 and the extending direction of the second trunk electrode line 203 and an included angle between the extending direction of the fourth branch electrodes 2021 and the extending direction of the second trunk electrode line 203 are 45°.

In some embodiments, an included angle between an extending direction of the above branch electrodes and the trunk electrode may also be 30°, 60° or other degrees. A specific included angle can be decided according to a practical situation, and is not described here.

In the present embodiment, it should be noted that other trunk electrode lines (not shown) are further disposed at an outer side of the first pixel electrodes 10 and at an outer side the second pixel electrodes 20, and positions of those trunk electrode lines are not described here.

In the present disclosure, it should be noted that the pixel structure 100 further includes a plurality of scan lines and a plurality of data lines. The scan lines and the data lines define the first pixels A and the second pixels B. In the present disclosure, the pixel structure 100 further includes a common line or other structures (not shown). A specific structure may be referred to conventional technologies, and is not described here.

Compared with conventional pixel structures, in a pixel structure provided by the present disclosure, a plurality of first pixels and a plurality of second pixels are alternately disposed along a first direction, an even number of the first pixels are disposed in a side-by-side manner along the second direction to form a first unit, an even number of the second pixels are disposed in a side-by-side manner along the second direction to form a second unit, and the first unit and the second unit are alternately disposed along the second direction. Therefore, a color shifting problem of special images displayed by high-end devices is fixed. Furthermore, because of a two-domain pixel design, a light transmittance of a display panel is ensured. As a result, an expansion of an application of multi-domain pixel design applied to high-end devices is realized.

The present embodiment further provides a display panel including the pixel structure 100 mentioned in the above embodiments.

Detailed descriptions of embodiments of the present disclosure are provided above. Principles and embodiments of the present disclosure are illustrated with reference to specific examples. The descriptions of the above embodiment are merely used to help those skilled in the art understand the present disclosure. Furthermore, for those skilled the art, specific embodiments and applications may be modified according to the spirit of the present disclosure. In summary, the contents of the specification shall not be construed as causing limitations to the present disclosure.

What is claimed is:

1. A pixel structure, comprising a plurality of first pixels and a plurality of second pixels arranged in an array manner, wherein the pixel structure comprises a first direction and a second direction;
the first pixels comprise a plurality of first pixel electrodes, the second pixels comprise a plurality of second pixel electrodes, a plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes;
the first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed; and
the first unit comprises two of the first pixels, the second unit comprises two of the second pixels, and the first direction is perpendicular to the second direction.

2. The pixel structure of claim 1, wherein the first direction is a row direction or a column direction, and the second direction is the row direction or the column direction.

3. The pixel structure of claim 2, wherein each of the first pixels comprises a first partition and a second partition, each of the first pixel electrodes comprises a first sub-pixel electrode and a second sub-pixel electrode, the first sub-pixel electrode is disposed in the first partition, the second sub-pixel electrode is disposed in the second partition, and a pattern of the first sub-pixel electrode and a pattern of the second sub-pixel electrode are different; and
each of the second pixels comprises a third partition and a fourth partition, each of the second pixel electrodes comprises a third sub-pixel electrode and a fourth sub-pixel electrode, the third sub-pixel electrode is disposed in the third partition, the fourth sub-pixel electrode is disposed in the fourth partition, and a pattern of the third sub-pixel electrode and a pattern of the fourth sub-pixel electrode are different.

4. The pixel structure of claim 3, wherein each of the first pixel electrodes further comprises a first trunk electrode line disposed between the first sub-pixel electrode and the second sub-pixel electrode, and the pattern of the first sub-pixel electrode and the pattern of the second sub-pixel electrode are symmetrically disposed with respect to the first trunk electrode line; and
each of the second pixel electrodes further comprises a second trunk electrode line disposed between the third sub-pixel electrode and the fourth sub-pixel electrode, and the pattern of the third sub-pixel electrode and the pattern of the fourth sub-pixel electrode are symmetrically disposed with respect to the second trunk electrode line.

5. The pixel structure of claim 4, wherein the first sub-pixel electrode comprises a plurality of first branch electrodes parallelly arranged, an extending direction of the first branch electrodes intersects an extending direction of the first trunk electrode line, the second sub-pixel electrode comprises a plurality of second branch electrodes parallelly arranged, an extending direction of the second branch electrodes intersects the extending direction of the first trunk electrode line, and the first branch electrodes and the second branch electrodes are symmetrically disposed with respect to the first trunk electrode line; and
the third sub-pixel electrode comprises a plurality of third branch electrodes parallelly arranged, an extending direction of the third branch electrodes intersects an extending direction of the second trunk electrode line, the fourth sub-pixel electrode comprises a plurality of fourth branch electrodes parallelly arranged, an extending direction of the fourth branch electrodes intersects the extending direction of the second trunk electrode line, and the third branch electrodes and the fourth branch electrodes are symmetrically disposed with respect to the second trunk electrode line.

6. The pixel structure of claim 5, wherein the first branch electrodes, the second branch electrodes, the third branch electrodes, and the fourth branch electrodes are strip-shaped electrodes.

7. The pixel structure of claim 5, wherein an included angle between the extending direction of the first branch electrodes and the extending direction of the first trunk electrode line and an included angle between the extending direction of the second branch electrodes and the extending direction of the first trunk electrode line are 45°; and
an included angle between the extending direction of the third branch electrodes and the extending direction of the second trunk electrode line and an included angle between the extending direction of the fourth branch electrodes and the extending direction of the second trunk electrode line are 45°.

8. A pixel structure, comprising a plurality of first pixels and a plurality of second pixels arranged in an array manner, wherein the pixel structure comprises a first direction and a second direction;
the first pixels comprise a plurality of first pixel electrodes, the second pixels comprise a plurality of second pixel electrodes, a plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes; and
the first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed.

9. The pixel structure of claim 8, wherein the first unit comprises two of the first pixels, and the second unit comprises two of the second pixels.

10. The pixel structure of claim 8, wherein the first direction is perpendicular to the second direction.

11. The pixel structure of claim 10, wherein the first direction is a row direction or a column direction, and the second direction is the row direction or the column direction.

12. The pixel structure of claim 11, wherein each of the first pixels comprises a first partition and a second partition, each of the first pixel electrodes comprises a first sub-pixel electrode and a second sub-pixel electrode, the first sub-pixel electrode is disposed in the first partition, the second sub-pixel electrode is disposed in the second partition, and a pattern of the first sub-pixel electrode and a pattern of the second sub-pixel electrode are different; and
each of the second pixels comprises a third partition and a fourth partition, each of the second pixel electrodes comprises a third sub-pixel electrode and a fourth sub-pixel electrode, the third sub-pixel electrode is disposed in the third partition, the fourth sub-pixel electrode is disposed in the fourth partition, and a pattern of the third sub-pixel electrode and a pattern of the fourth sub-pixel electrode are different.

13. The pixel structure of claim 12, wherein the first pixel electrode further comprises a first trunk electrode line disposed between the first sub-pixel electrode and the second sub-pixel electrode, and the pattern of the first sub-pixel electrode and the pattern of the second sub-pixel electrode are symmetrically disposed with respect to the first trunk electrode line; and
the second pixel electrode further comprises a second trunk electrode line disposed between the third sub-pixel electrode and the fourth sub-pixel electrode, and the pattern of the third sub-pixel electrode and the pattern of the fourth sub-pixel electrode are symmetrically disposed with respect to the second trunk electrode line.

14. The pixel structure of claim 13, wherein the first sub-pixel electrode comprises a plurality of first branch electrodes parallelly arranged, an extending direction of the first branch electrodes intersects an extending direction of the first trunk electrode line, the second sub-pixel electrode comprises a plurality of second branch electrodes parallelly arranged, an extending direction of the second branch electrodes intersects the extending direction of the first trunk electrode line, and the first branch electrodes and the second branch electrodes are symmetrically disposed with respect to the first trunk electrode line; and
the third sub-pixel electrode comprises a plurality of third branch electrodes parallelly arranged, an extending direction of the third branch electrodes intersects an extending direction of the second trunk electrode line, the fourth sub-pixel electrode comprises a plurality of fourth branch electrodes parallelly arranged, an extending direction of the fourth branch electrodes intersects the extending direction of the second trunk electrode line, and the third branch electrodes and the fourth branch electrodes are symmetrically disposed with respect to the second trunk electrode line.

15. The pixel structure of claim 14, wherein the first branch electrodes, the second branch electrodes, the third branch electrodes, and the fourth branch electrodes are strip-shaped electrodes.

16. The pixel structure of claim 14, wherein an included angle between the extending direction of the third branch electrodes and the extending direction of the second trunk electrode line and an included angle between the extending direction of the fourth branch electrodes and the extending direction of the second trunk electrode line are 45°; and
an included angle between the extending direction of the third branch electrodes and the extending direction of the second trunk electrode line and an included angle between the extending direction of the fourth branch electrodes and the extending direction of the second trunk electrode line are 45°.

17. A display panel, comprising a pixel structure, wherein the pixel structure comprises a plurality of first pixels and a plurality of second pixels arranged in an array manner, and the pixel structure comprises a first direction and a second direction;
the first pixels comprise a plurality of first pixel electrodes, the second pixels comprise a plurality of second pixel electrodes, a plurality of patterns of the first pixel electrodes are symmetrically disposed with respect to a plurality of patterns of the second pixel electrodes, and the plurality of patterns of the second pixel electrodes are symmetrically disposed with respect to the plurality of patterns of the first electrodes; and
the first pixels and the second pixels are alternately disposed along the first direction, an even number of the first pixels are disposed in a side-by-side manner along the second direction to form a first unit, an even number of the second pixels are disposed in a side-by-side manner along the second direction to form a second unit, and the first unit and the second unit are alternately disposed.

18. The display panel of claim 17, wherein the first unit comprises two of the first pixels, and the second unit comprises two of the second pixels.

19. The display panel of claim 17, wherein the first direction is perpendicular to the second direction.

20. The display panel of claim 18, wherein the first direction is a row direction or a column direction, and the second direction is the row direction or the column direction.
